(19) United States
(12) Patent Application Publication
(10) Pub. No.: US 2026/0078816 A1
(43) Pub. Date: Mar. 19, 2026

(54) TRANSMISSION WITH ENCAPSULATED GEAR

(71) Applicant: Schaeffler Technologies AG & Co. KG, Herzogenaurach (DE)

(72) Inventors: Marc HELFER, Ottrott (FR); Benjamin STOBER, Forstfeld (FR); Felix VOGEL, Sinzheim (DE); Matthias SCHELL, Hemhofen (DE)

(21) Appl. No.: 18/717,389

(22) PCT Filed: Nov. 11, 2022
(86) PCT No.: PCT/DE2022/100839

§ 371 Date: Jun. 6, 2024

(30) Foreign Application Priority Data
Dec. 7, 2021 (DE) 10 2021 132 154.9

(51) Int. Cl. F16H 57/04

(52) U.S. Cl. CPC F16H 57/0423; F16H 57/0412; F16H 57/045; F16H 57/0457; F16H 57/0483

(57) ABSTRACT

The invention relates to a transmission (1) for the powertrain of a motor vehicle, comprising a housing (2) and a differential unit (4) which is arranged in a receiving area (3) of the housing (2). A gear (5) of the differential unit (4) is used to convey a hydraulic fluid from a collecting chamber (7), which is found on the lower face (6) of the housing (2) with respect to a planned installation position in a gravitational field, to the upper face (8) of the housing (2) in the circumferential direction during operation, said upper face facing away from the lower face (6). The gear (5) is housed by means of at least one conducting element (9, 10) which is fixed to the housing, and the at least one conducting element (9, 10) is designed to conduct hydraulic fluid conveyed in the circumferential direction by the gear (5) at least partly in an axial manner in the direction of a required lubrication and/or cooling location (12) within the receiving chamber (3) at a circumferential region (11) and/or in the direction of a transmission chamber (13) arranged adjacently to the receiving chamber (3).

### CROSS-REFERENCE TO RELATED APPLICATION

The present application is the U.S. National Phase of PCT Patent Application Number PCT/DE2022/100839, filed on Nov. 11, 2022, which claims priority to German Patent Application Number 10 2021 132 154.9, filed Dec. 7, 2021, the entire disclosures of which are incorporated by reference herein.

### TECHNICAL FIELD

The disclosure relates to a transmission for a powertrain of a motor vehicle, having a housing and a differential unit arranged in a receiving area of the housing. The transmission is more preferably implemented as a hybrid transmission and more preferably also has an electric machine.

### BACKGROUND

Transmissions of the type in question are already sufficiently known in the prior art. In this regard, EP 3 534 042 A1, for example, discloses a powertrain of a motor vehicle with a transmission. Here, a collecting container is provided in a housing of the transmission, which stores lubricating oil. A supply path is further provided in this housing for supplying the lubricating oil supplied by a differential gear mechanism during reverse travel of the motor vehicle. An outlet passage connected to an outlet port of an oil pump is also connected to the collection container.

In previous transmission designs, it has been found that existing transmission losses arise in particular from the drag torques generated when the transmission components, such as the differential unit, move/rotate due to an oil sump in the transmission. At the same time, the individual components of the transmission, such as gears, bearings and shafts, should be sufficiently lubricated/cooled.

### SUMMARY

It is therefore the object of the present disclosure to provide a transmission whose efficiency losses, which are caused during operation by coolant and/or lubricant delivery, are reduced, while at the same time ensuring a sufficient oil supply for the longevity of the transmission.

This is achieved according to the disclosure in that a gear of the differential unit is used to convey a hydraulic fluid from a collecting chamber, which is found on the lower face of the housing with respect to a planned installation position in a gravitational field, to the upper face of the housing in the circumferential direction during operation, said upper face facing away from/opposite the lower face, wherein the gear is housed by means of at least one guide element which is fixed to the housing, and the at least one guide element is designed to conduct the hydraulic fluid conveyed in the circumferential direction by the gear at least partly in an axial manner in the direction of a required lubrication and/or cooling location within the receiving area at a (specific) circumferential region of the gear and/or in the direction of a transmission chamber arranged adjacently to the receiving area.

Such an arrangement of a guide element immediately adjacent to the gear of the differential results in an efficient and direct conveying of part of the hydraulic fluid conveyed directly by the gear wheel to the various points of need. This results in targeted lubrication/cooling of the transmission components.

Further advantageous embodiments are claimed in the sub-claims and explained in more detail below.

Accordingly, it is also advantageous if the at least one guide element has a disk-shaped side wall region arranged (immediately) axially next to the gear and/or has an outer wall region that radially covers/projects beyond a toothing of the gear from the outside (axially). As a result, the gear is encapsulated/surrounded as tightly as possible by the guide element. To reduce manufacturing costs, the guide element is further preferably made of a plastic material.

In addition, it is advantageous if the at least one guide element forms/has a blade section (in the sense of a deflecting/diverting blade) on the circumferential region (of the gear), which blade section causes a deflection of part of the hydraulic fluid conveyed by the gear in the circumferential direction in the axial direction. This also further simplifies the design of the guide element.

Furthermore, it is advantageous if the blade section is designed such that it deflects a portion of hydraulic fluid in the axial direction both in a first direction of rotation and in a second direction of rotation of the gear (opposite to the first direction of rotation). This ensures the hydraulic fluid distribution regardless of a selected gear of the transmission and thus in particular both in a forward gear and in a reverse gear.

Furthermore, it is expedient if the at least one guide element has/forms a trough for storing a certain amount of hydraulic fluid axially next to the gear. This means that the diverted hydraulic fluid is temporarily stored and distributed as specifically and efficiently as possible to the locations to be lubricated/cooled.

Accordingly, it is also expedient if the trough is hydraulically connected via a connecting channel to a rolling bearing that supports a shaft component of the differential unit. This results in particularly efficient lubrication of the corresponding rolling bearings.

It is also advantageous if the at least one guide element is designed in such a way that a second partial quantity of the hydraulic fluid conveyed in the circumferential direction from the lower face to the upper face is conveyed further in the circumferential direction beyond the circumferential region effecting the axial deflection of a first partial quantity of the hydraulic medium. As a result, a portion of hydraulic fluid is preferably also conveyed to an area of the gear of the differential unit that is in mesh with another transmission gear. The efficiency of the lubricant/coolant supply is further increased.

In this context, it has also proven to be advantageous if the at least one guide element is provided with an opening penetrating its blade section in the circumferential direction. This keeps the production of the guide element as simple as possible.

If a guide element is arranged axially on both sides of the gear, i.e., if a guide element is arranged on each axial side of the gear, the hydraulic fluid is distributed even more specifically.

It has proven to be expedient if, on the one hand, a first guide element forms a side wall region and a blade section, and on the other hand, a further, second guide element has, in particular, a side wall region, wherein the side wall region of the second guide element is arranged on a side of the gear wheel axially facing away from the side wall region of the first guide element. This results in the gear being encapsulated on as many sides as possible.

It is therefore also advantageous if the two guide elements have a common blade section, which blade section is designed such that it deflects the hydraulic fluid conveyed by the gear in the circumferential direction in both (opposite) axial directions.

The blade section can preferably be designed in such a way that it distributes the hydraulic fluid in equal parts in the axial direction, i.e., it deflects the same amount/volume flow both to the first axial side and to the second axial side. This allows lubrication/cooling to take place in a targeted manner.

The disclosure will now be explained in more detail below with reference to figures, in which context various exemplary embodiments are also illustrated.

### BRIEF DESCRIPTION OF THE DRAWINGS

In the Figures:

FIG. 1 shows a perspective view of a transmission designed according to a first exemplary embodiment in the area of its differential unit, wherein a gear of the differential unit encapsulated by two guide elements and a blade section attached to a guide element can be seen,

FIG. 2 shows a longitudinal sectional view of the transmission according to FIG. 1, wherein a trough formed by a first guide element for temporarily storing a hydraulic fluid can be seen,

FIG. 3 shows a longitudinal sectional view of the transmission of FIG. 1 in a further sectional plane that differs from the sectional plane of FIG. 2, such that a connecting channel connecting the trough of the first guide element to a first rolling bearing can be seen,

FIG. 4 shows a longitudinal sectional view of the transmission of FIG. 1 in a further sectional plane of FIGS. 2 and 3, wherein a connecting channel connecting a trough of the second guide element to a second rolling bearing is shown,

FIG. 5 shows a longitudinal sectional view of the transmission of FIG. 1 in a further sectional plane that differs from the sectional planes of FIGS. 2 to 4, whereby a hydraulic fluid supply to the gear is shown,

FIG. 6 shows a perspective view of the partially sectioned transmission of FIGS. 1 to 5, wherein the first guide element is clearly recognizable in its extension,

FIG. 7 shows a sectional view of the transmission of FIG. 1, which also shows further transmission gears operatively connected to the gear of the differential unit,

FIGS. 8 and 9 show two further sectional views of the transmission of FIG. 1, whereby the hydraulic fluid supply of two further rolling bearings within the transmission is shown,

FIG. 10 shows a perspective view of a part of a transmission according to the disclosure according to a second exemplary embodiment, wherein the first guide element can clearly be seen in its overall shape,

FIG. 11 shows a detailed representation of the blade section of the first guide element illustrated in FIG. 10,

FIG. 12 shows a side view of the part of the transmission shown in FIG. 10,

FIG. 13 shows a perspective view of a transmission according to the disclosure according to a third exemplary embodiment, wherein the blade section of the first guide element is illustrated in detail,

FIG. 14 shows a perspective view of a transmission according to the disclosure according to a fourth exemplary embodiment, wherein the distribution of the hydraulic fluid can be seen by means of the blade section of the first guide element,

FIG. 15 shows a perspective detailed view of the transmission of FIG. 14, showing an axial passage in a web of the blade section,

FIG. 16 shows a sectional view of the transmission of FIG. 14, whereby further transmission gears operatively connected to the gear of the differential unit can be seen,

FIG. 17 shows a sectional view of the transmission in the area of the blade section, wherein a flow generated in a reverse gear is shown,

FIG. 18 shows a perspective view of the transmission of FIG. 14, wherein the more detailed axial division of the hydraulic fluid flow shown in FIG. 17 can be seen,

FIG. 19 shows a perspective view of a transmission according to the disclosure according to a fifth exemplary embodiment, again in the area of the blade section surrounding the gear, again showing a flow generated in a reverse gear,

FIG. 20 shows a side view of the blade section of FIG. 19,

FIG. 21 shows an outer view of the blade section of FIG. 19,

FIG. 22 shows a perspective view of the transmission according to FIGS. 19 to 21, wherein flow arrows represent a percentage distribution of the hydraulic fluid at a certain speed in a forward gear, and

FIG. 23 shows a perspective view of the transmission of FIGS. 19 to 21 in the area of a second guide element, wherein an opening within the blade section for conveying hydraulic fluid in the circumferential direction can also be seen.

### DESCRIPTION OF EMBODIMENTS

The figures are merely schematic in nature and serve solely for understanding the disclosure. Identical elements are provided with the same reference symbols. Furthermore, the various features of the different exemplary embodiments can also be freely combined with one another.

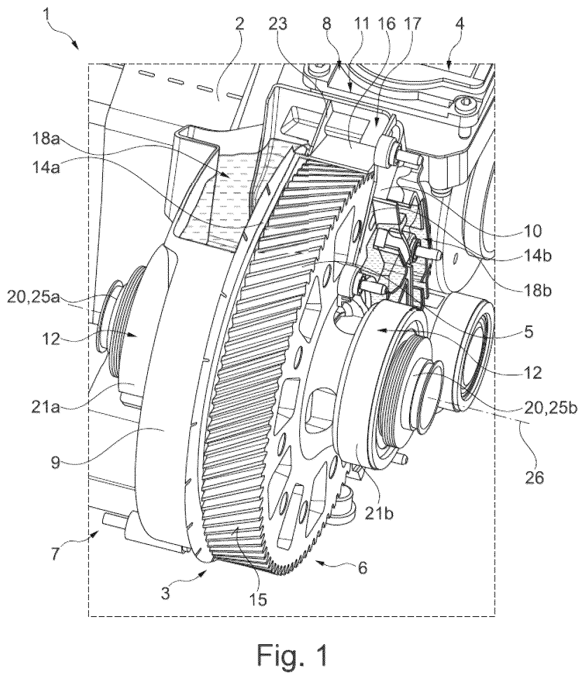

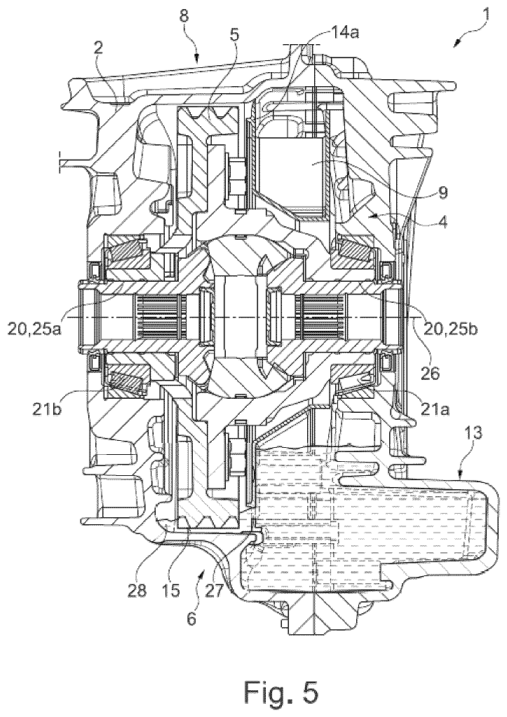

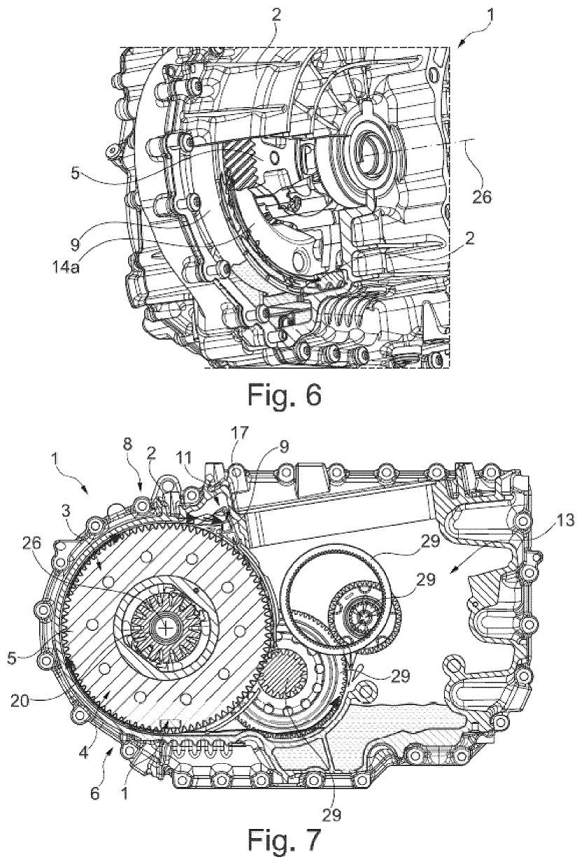

In FIGS. 1 to 9, a first exemplary embodiment of a transmission 1 according to the disclosure is first illustrated. The transmission 1 has a differential unit 4. The differential unit 4 is coupled in the usual way on the input side with other transmission components, such as transmission gears 29, which are summarized as a gear unit 14 in FIG. 5, and is further connected on the output side to the wheels of the motor vehicle.

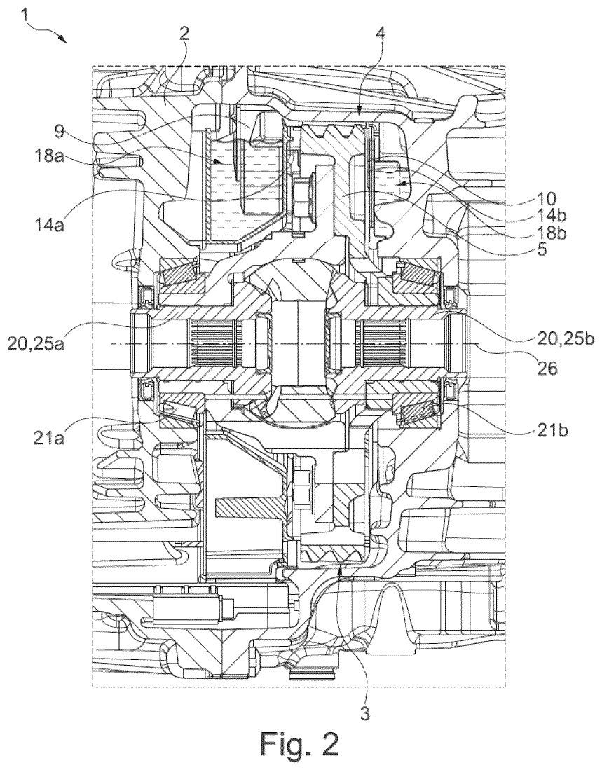

The differential unit 4 has a gear 5 forming the input of the differential unit 4, which is therefore also referred to as an input gear. FIG. 2, for example, also shows the corresponding output shafts 25a, 25b, which are further connected to the wheels of the motor vehicle, to form the output of the differential unit 4.

For the sake of completeness, it should be pointed out that the directional information used here, i.e., axially, radially and in the circumferential direction, relates to an axis of rotation 26 of the gear 5 of the differential unit 4. Axially/an axial direction is therefore to be understood as a direction along/parallel to the axis of rotation 26; radially/a radial direction is to be understood as a direction perpendicular to the axis of rotation 26; and a circumferential direction is to be understood as a direction along an imaginary circular line that runs concentrically around the axis of rotation 26.

In addition to the differential unit 4, the transmission 1, as already mentioned, has the further gear unit 14. The gear unit 14 can, for example, be designed as a switchable gear unit/a multi-speed transmission/a manual transmission and can therefore be coupled to the gear 5 of the differential unit 4 via several different transmission stages.

In this context, it should be noted in principle that the transmission 1 is preferably designed as a hybrid transmission and therefore, in a particularly preferred embodiment, has an electric machine (not shown here for the sake of clarity) for driving the motor vehicle. The electric machine is also preferably housed in the housing 2 of the transmission 1. An output/rotor of the electric machine is preferably connected to the differential unit 4 by means of the gear unit 14.

In conjunction with FIG. 5 it can then be seen that the transmission chamber 13 accommodating the gear unit 14 forms a collecting chamber 7. This collecting chamber 7 is designed to form a lower face 6 of the housing 2 in relation to the intended installation position of the transmission 1 in the gravitational field. The collecting chamber 7, also known as an oil sump, is therefore used during operation to collect and temporarily store a certain amount of oil/hydraulic fluid and is therefore provided on the lower face 6.

As can also be seen in FIG. 5, the differential unit 4 is accommodated in a receiving area 3 of the housing 2, which receiving area 3 is spatially separated from the collecting chamber 7 and thus also from the transmission chamber 13. The receiving area 3 also forms a (first) transmission chamber, which is separated from the (second) transmission chamber 13 accommodating the gear unit 24. The collecting chamber 7 is hydraulically connected to the receiving area 3 via a passage opening 27. On a lower face 6 of the receiving area 3, which is also seen in relation to the intended installation position and under consideration of the effective gravitational field, a collecting well 28 is formed, which collecting well 28 is connected to the collecting chamber 7 directly via the passage opening 27. The gear 5 protrudes radially into this collecting well 28. During operation, a hydraulic fluid flowing in through the passage opening 27 is transported further in the circumferential direction from the collecting well 28 directly as the gear 5 rotates. During operation, the gear 5, in particular with its toothing 15 (external toothing), is immersed directly in the hydraulic fluid located in the collecting well 28 and takes it with it in the circumferential direction.

It should be noted that in addition to or as an alternative to the passage opening 27 arranged below the gear 5, at least one or more further passage openings 27 can be present. In particular, it is preferred to provide a further passage opening below an intermediate shaft, which supplies a further (second) wheel set.

According to the disclosure, the gear 5 is enclosed by at least one, here even two, guide elements 9, 10. A first guide element 9 is arranged essentially on a first axial side of the gear 5, while a second guide element 10 is arranged essentially on a second axial side of the gear 5 opposite the first axial side. The guide elements 9; 10 are supported/fastened on the housing 2. Both guide elements 9, 10 are preferably made from a plastic material, more preferably by injection molding.

In an overall consideration of FIGS. 1 to 9, the first guide element 9 has a (first) side wall region 14a, which is arranged directly on the first axial side of the gear 5. The first guide element 9 also has an outer wall region 16 which covers/projects beyond the gear 5 radially from the outside in the axial direction. That outer wall region 16 directly forms a blade section 17 on a specific circumferential region 11 (viewed in the circumferential direction), which blade section 17 is used according to the disclosure to deflect/redirect/distribute the hydraulic fluid conveyed by the gear 5 in the circumferential direction from the lower face 6 to an upper face 8 of the housing 2 in the axial direction to both sides of the gear 5.

The second guide element 10 also has a (second) side wall region 14b, which is arranged axially, opposite to the first side wall region 14a on the side of the gear 5 and thus to the second axial side of the gear 5. Furthermore, the second guide element 10 has an outer wall region 30 running in the circumferential direction, which continues in the circumferential direction (seen in a first direction of rotation of the gear 5) following/behind the blade section 17. This outer wall region 30 of the second guide element 10 also covers the gear 5 in the axial direction from a radial outside.

Furthermore, a (first) trough 18a is formed on the first guide element 9. This trough 18a directly collects and temporarily stores a portion of hydraulic fluid that is diverted axially (towards the first axial side of the gear 5) by the blade section 17 during operation. The trough 18a is closed in particular towards the lower face 6. The first guide element 9 completely forms this trough 18a.

The second guide element 10 also forms a (second) trough 18b, which temporarily stores the hydraulic fluid deflected axially by the blade section 17 (towards the second axial side of the gear 5). This second trough 18b is formed both by the second guide element 10 and by the housing 2.

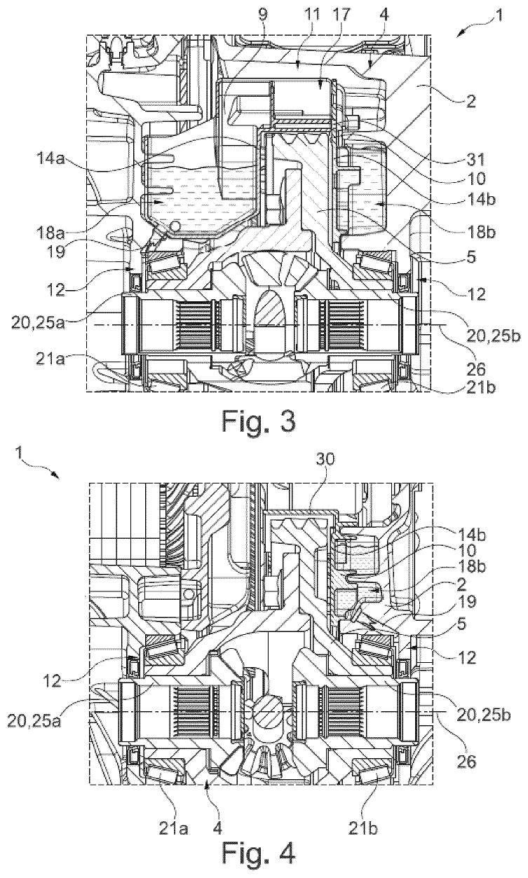

In conjunction with FIGS. 3 and 4 as well as 8 and 9 it can be seen that the troughs 18a, 18b are hydraulically connected directly to lubrication and/or cooling locations 12, here in the form of rolling bearings 21a, 21b, 21c, 21d.

Two rolling bearings 21a, 21b are assigned to the differential unit 4. They each serve to support a shaft component 20 of the differential unit 4. The first trough 18a is connected directly to a first rolling bearing 21a via a connecting channel 19 (FIG. 3). The second trough 18b is further connected directly to a further rolling bearing 21b via a connecting channel 19. The two (first and second) rolling bearings 21a, 21b support the output shafts 25a, 25b relative to the housing 2.

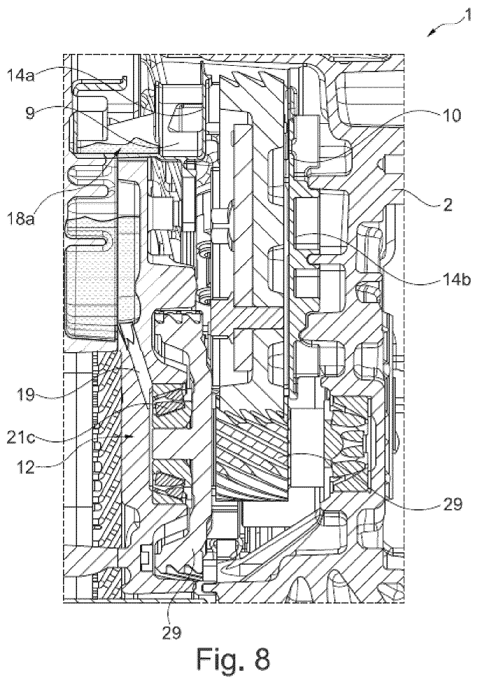

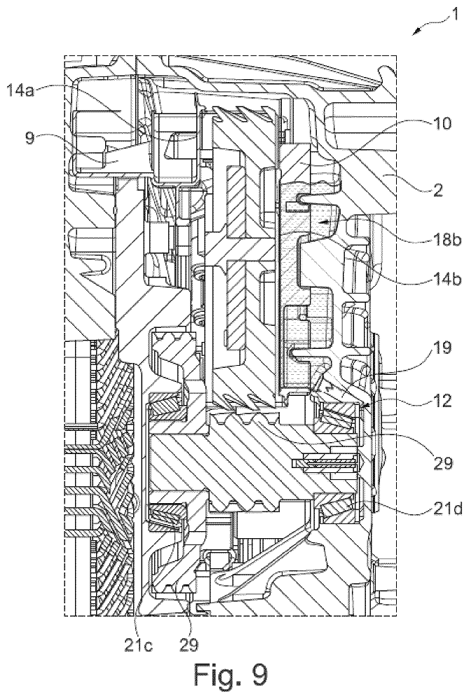

In FIGS. 8 and 9 it can also be seen that the troughs 18a, 18b are preferably hydraulically connected to further bearings of the transmission 1. Further connecting channels 19 connect the respective trough 18a, 18b to at least one further (third or fourth) rolling bearing 21c, 21d. The third rolling bearing 21c and the fourth rolling bearing 21d are preferably used to support a transmission gear 29 which is in direct mesh with the gear 5.

It should be noted that the further exemplary embodiments described below are based on the first exemplary embodiment and thus have the basic structure and the basic functionality of this first exemplary embodiment. For the sake of brevity, only the differences between these exemplary embodiments will be described.

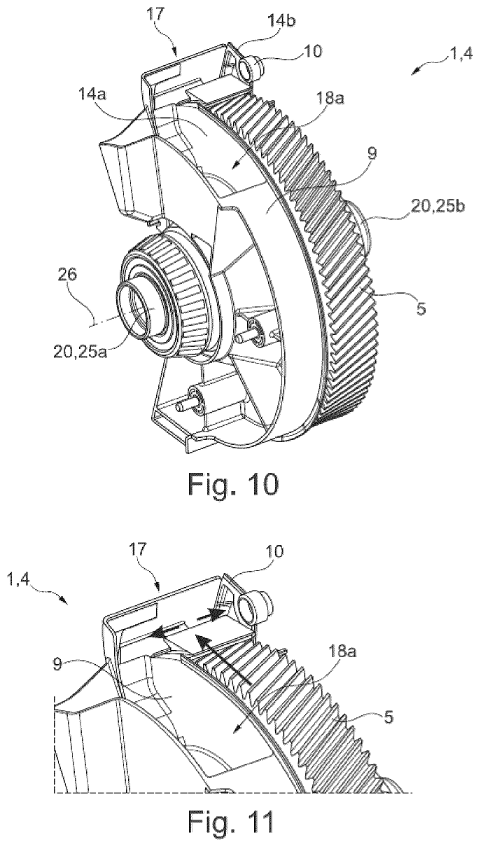

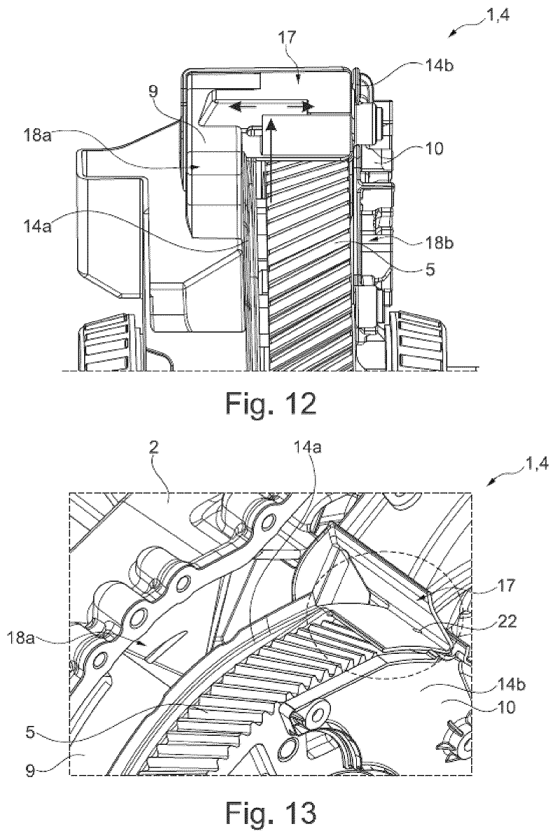

In conjunction with FIGS. 10 to 12, a second exemplary embodiment of the transmission 1 according to the disclosure is illustrated. The blade section 17 is designed in such a way that it distributes the hydraulic fluid conveyed in the circumferential direction equally on both axial sides. The hydraulic fluid conveyed in the circumferential direction, which is deflected by the blade section 17, is thus 50%/half deflected to the first axial side of the gear 5/fed to the first trough 18a and 50%/half 18b deflected to the second axial side of the gear 5/fed to the second trough 18b.

It should be noted in this context (also applicable to the first exemplary embodiment) that the blade section 17, which is formed directly on the first guide element 9, also diverts hydraulic fluid to the second guide element 10. Preferably, the hydraulic fluid deflected by the blade section 17 towards the second axial side of the gear 5 flows axially through the second guide element 10 through a corresponding through opening 31 (FIG. 3). In FIGS. 10 to 12, there is also no web 23 (stiffening web), which is still present in FIG. 1.

With the third exemplary embodiment of FIG. 13, it can also be seen that the blade section 17 can in principle be provided with a corresponding through hole/opening 22 penetrating the blade section 17 in the circumferential direction, which allows a partial quantity of the hydraulic fluid conveyed in the circumferential direction through the gear 5 to pass in the circumferential direction and to supply it to corresponding further areas of the transmission 1, for example directly to the area of the tooth contact between the gear 5 and the transmission gearwheel 29.

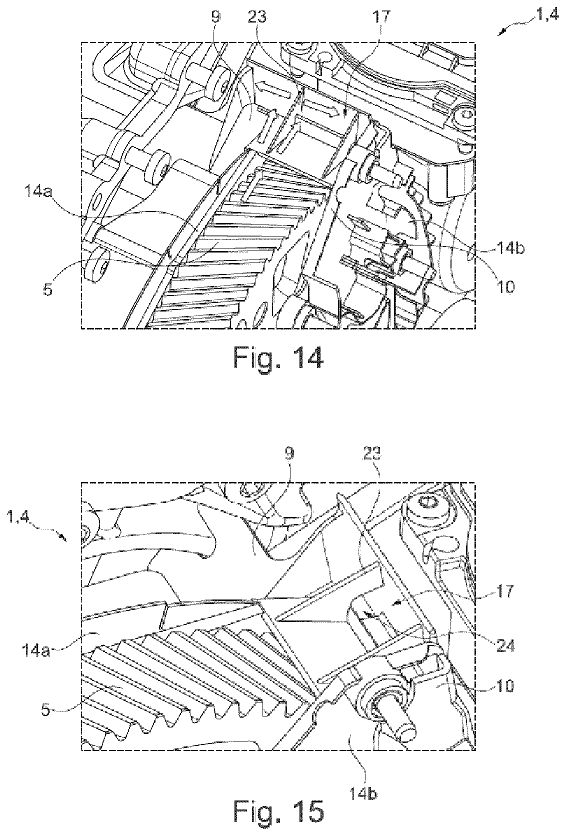

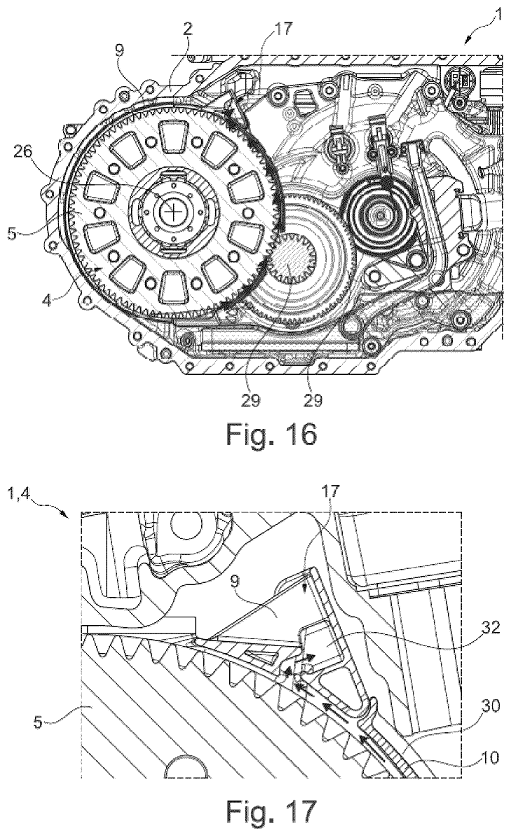

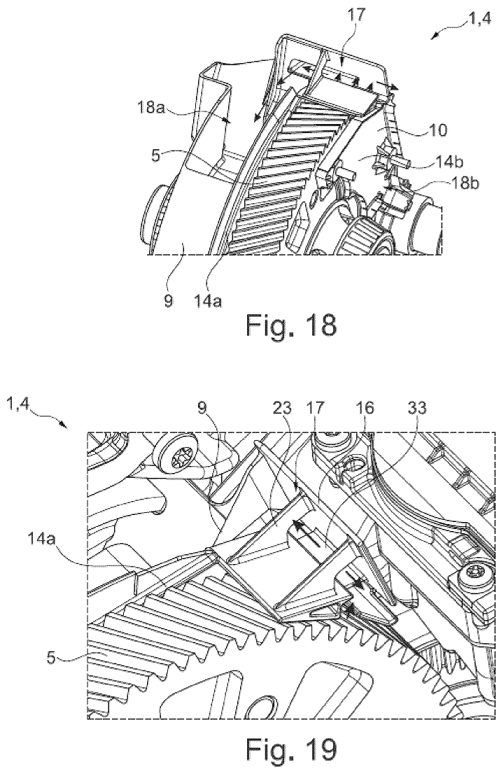

With the fourth exemplary embodiment of FIGS. 14 to 18, the blade section 17 is designed in such a way that it causes an axial deflection of the hydraulic fluid conveyed by the gear 5 not only when the gear 5 rotates in the first direction of rotation, but also in an opposite second direction of rotation. According to FIG. 17 and FIG. 18, the blade section 17 is shaped in such a way that it forms a corresponding reverse chamber 32, which in turn collects part of the hydraulic fluid conveyed in the second direction of rotation and conveys it in the axial direction to the troughs 18a, 18b, preferably in equal parts. An axial passage 24 through the web 23 can also be seen in FIG. 15.

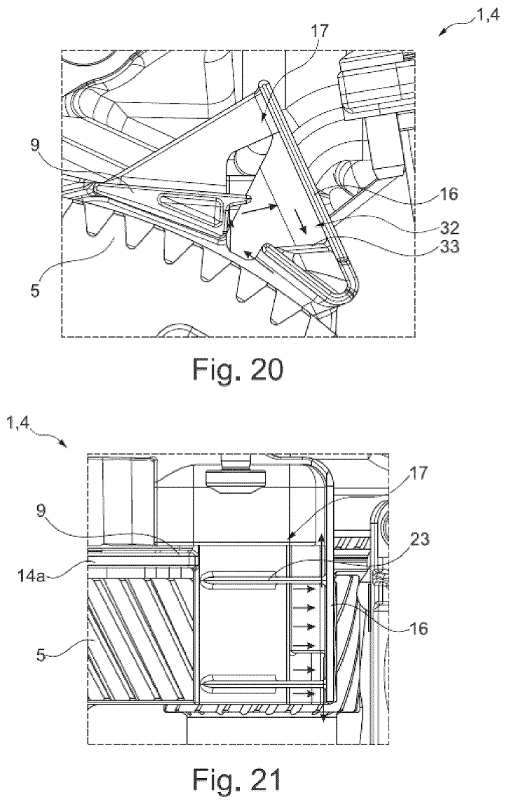

In connection with the fifth exemplary embodiment of FIGS. 19 to 23 it is further illustrated that a further rib 33 is preferably designed specifically to collect the hydraulic fluid conveyed in the reverse gear/when the gear 5 rotates in the second direction of rotation and to pass it on from there in the axial direction.

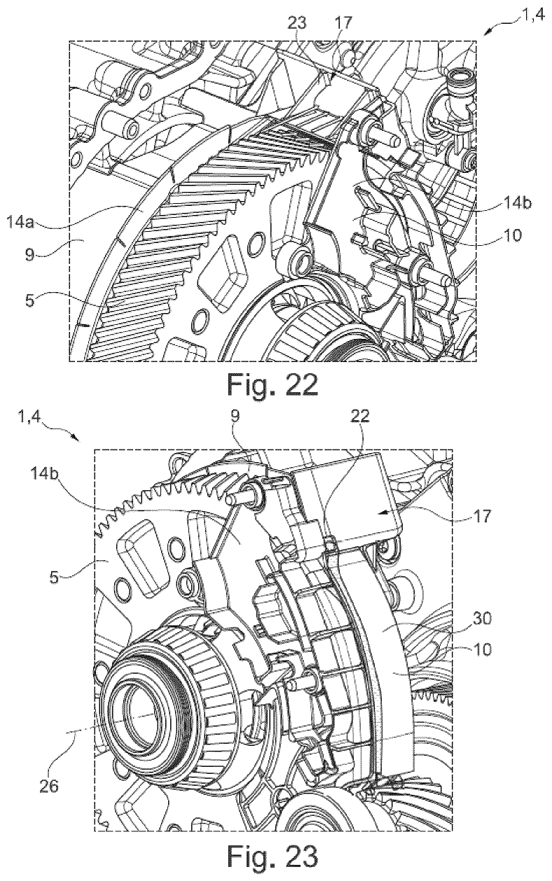

In FIGS. 22 and 23, it can finally be seen that the size of the opening 22 is preferably chosen such that a proportion of 20% of the hydraulic fluid conveyed at a specific speed of the gear 5 is conveyed in the circumferential direction past the blade section 17 or through it via the opening 22 and 80% is diverted axially.

### LIST OF REFERENCE SIGNS

1 Transmission
2 Housing
3 Receiving area
4 Differential unit
5 Gear
6 Lower face
7 Collection space
8 Upper face
9 First guide element
10 Second guide element
11 Circumferential region
12 Lubrication and/or cooling location
13 Transmission chamber
14a First side wall region
14b Second side wall region
15 Toothing
16 Outer wall region of the first guide element
17 Blade section
18a First cheek
18b Second cheek
19 Connecting channel
20 Shaft component
21a First rolling bearing
21b Second rolling bearing
21c Third rolling bearing
21d Fourth rolling bearing
22 Opening
23 Web
24 Gear unit
25a First output shaft
25b Second output shaft
26 Axis of rotation
27 Passage opening
28 Collecting well
29 becomes 15
30 Outer wall region of the second guide element
31 Through-opening
32 Chamber
33 Ribs

1. A transmission for a powertrain of a motor vehicle comprising: a housing and a differential unit which is arranged in a receiving area of the housing, wherein a gear of the differential unit is used to convey a hydraulic fluid from a collecting chamber, which is found on a lower face of the housing with respect to a planned installation position in a gravitational field, to an upper face of the housing in a circumferential direction during operation, said upper face facing away from the lower face, wherein the gear is housed by means of at least one guide element which is fixed to the housing, and the at least one guide element is designed to conduct hydraulic fluid conveyed in the circumferential direction by the gear at least partly in an axial manner in a direction of a required lubrication and/or cooling location within the receiving area at a circumferential region and/or in the direction of a transmission chamber arranged adjacently to the receiving area.

2. The transmission according to claim 1, wherein the at least one guide element has a disk-shaped side wall region arranged axially next to the gear and/or has an outer wall region which covers a toothing of the gear radially from the outside.

3. The transmission according to claim 1, wherein the at least one guide element has a blade section on the circumferential region, which blade section causes a deflection in the axial direction of part of the hydraulic fluid conveyed by the gear in the circumferential direction.

4. The transmission according to claim 3, wherein the blade section is designed such that it deflects a portion of hydraulic fluid in the axial direction both in a first direction of rotation and in a second direction of rotation of the gear.

5. The transmission according to claim 1, wherein the at least one guide element has a trough axially next to the gear for storing a certain amount of hydraulic fluid.

6. The transmission according to claim 5, wherein the trough is hydraulically connected via a connecting channel to a rolling bearing supporting a shaft component of the differential unit.

7. The transmission according to claim 1, wherein the at least one guide element is designed such that a second partial quantity of the hydraulic fluid conveyed in the circumferential direction from the lower face to the upper face is conveyed further in the circumferential direction beyond the circumferential region effecting the axial deflection of a first partial quantity of the hydraulic fluid.

8. The transmission according to claim 7, wherein the at least one guide element is provided with an opening penetrating its blade section in the circumferential direction.

9. The transmission according to claim 1, wherein a guide element is arranged axially on both sides of the gear.

10. The transmission according to claim 9, wherein the two guide elements have a common blade section, which blade section is designed such that it deflects the hydraulic fluid conveyed by the gear in the circumferential direction in both axial directions.

11. A transmission comprising:
a housing; and
a differential unit, wherein the differential unit is arranged in a receiving area of the housing, wherein the differential unit includes a gear configured to convey a hydraulic fluid from a collecting chamber to an upper face of the housing in a circumferential direction, wherein the collecting chamber is located on a lower face of the housing, wherein the gear is housed by at least one guide element fixed to the housing, wherein the at least one guide element is configured to axially conduct hydraulic fluid conveyed in the circumferential direction by the gear in a selected direction.

12. The transmission according to claim 1, wherein the at least one guide element includes a disk-shaped side wall region arranged axially next to the gear.

13. The transmission according to claim 1, wherein the at least one guide element includes an outer wall region covering a toothing.

14. The transmission according to claim 1, wherein the at least one guide element includes a blade section located on a circumferential region, wherein the blade section is configured to axially deflect a portion of the hydraulic fluid conveyed by the gear in the circumferential direction.

15. The transmission according to claim 14, wherein the blade section is configured to deflect a portion of hydraulic fluid in the axial direction both in a first direction of rotation of the gear and in a second direction of rotation of the gear.

16. The transmission according to claim 1, wherein the at least one guide element includes a trough axially next to the gear for storing hydraulic fluid.

17. The transmission according to claim 1, wherein the at least one guide element includes an opening penetrating a blade section of the at least one guide element in the circumferential direction.

18. The transmission according to claim 1, wherein the at least one guide element comprises a first guide element and a second guide element, wherein the first guide element and the second guide element are arranged axially on both sides of the gear.

19. The transmission according to claim 18, wherein the first guide element and the second guide element two guide elements have a common blade section, wherein the common blade section is configured to deflect the hydraulic fluid conveyed by the gear in the circumferential direction in both axial directions.

20. A method comprising:
providing a transmission including a transmission housing and a differential unit;
conveying in a circumferential direction, with a gear of the differential unit, a hydraulic fluid from a collecting chamber located on a lower face of a transmission housing to an upper face of the transmission housing; and
axially conducting the hydraulic fluid conveyed in the circumferential direction to at least one of a lubrication location, a cooling location, or a transmission chamber.
